(19) United States
(12) Patent Application Publication
(10) Pub. No.: US 2023/0138200 A1
(43) Pub. Date: May 4, 2023

(54) SECURITY MANAGEMENT METHOD AND SYSTEM FOR BLENDED ENVIRONMENT

(71) Applicant: AJOU UNIVERSITY INDUSTRY-ACADEMIC COOPERATION FOUNDATION, Suwon-si (KR)

(72) Inventors: Jin Kwak, Gyeonggi-do (KR); Min Kyung Lee, Gyeonggi-do (KR)

(73) Assignee: AJOU UNIVERSITY INDUSTRY-ACADEMIC COOPERATION FOUNDATION, Suwon-si (KR)

(21) Appl. No.: 17/979,965

(22) Filed: Nov. 3, 2022

(30) Foreign Application Priority Data
Nov. 3, 2021 (KR) 10-2021-0150046

(51) Int. Cl. H04L 9/40

(52) U.S. Cl. CPC H04L 63/205; H04L 63/1491; H04L 63/1425

(57) ABSTRACT

A security management method of Internet of blended environment (IoBE) in which a plurality of environments are connected to each other through a network includes: detecting a security anomaly occurring through an attack surface existing in a device included in each of the plurality of environments in the IoBE or in a network connection section between the plurality of environments; collecting attack data related to the detected security anomaly, and analyzing an attack type based on the collected data; dynamically combining response techniques based on the analyzed attack type; and performing an automatic response to the security anomaly based on the combined response techniques.

### CROSS-REFERENCE TO RELATED APPLICATION

This application claims the benefit of Korean Patent Application No. 10-2021-0150046, filed on Nov. 3, 2021, in the Korean Intellectual Property Office, the disclosure of which is incorporated herein in its entirety by reference.

### BACKGROUND

### 1. Field

The present disclosure relates to a security management method and system in a blended environment.

### 2. Description of the Related Art

With the recent development of IT technology, beyond the simple Internet of Things (IoT), the speed of development of new technologies and platforms is rapidly accelerating, with the advent of Massive IoT, in which all devices in life are connected to each other at high density through a network. In addition, a concept in which various convergence environments such as smart factories, digital healthcare, and smart grids are complexly connected to each other through networks or sensing technologies is emerging.

However, as described above, when various environments (convergence environments) are complexly connected to each other through a network to form a blended environment, due to the hyper-connectivity of the blended environment, areas where security threats may occur may be diversified. Accordingly, as the number of security incidents increases rapidly due to the increase of an attack surface where cyber attacks may occur, a method capable of effectively responding to various and blended security threats in such a blended environment is required.

### SUMMARY

Provided are a security management method and system that may be applied to a blended environment in which various environments are interconnected through a network.

According to an aspect of an embodiment, a security management method of Internet of blended environment (IoBE) in which a plurality of environments are connected to each other through a network includes: detecting a security anomaly occurring through an attack surface existing in a device included in each of the plurality of environments in the IoBE or in a network connection section between the plurality of environments; collecting attack data related to the detected security anomaly, and analyzing an attack type based on the collected data; dynamically combining response techniques based on the analyzed attack type; and performing an automatic response to the security anomaly based on the combined response techniques.

According to an exemplary embodiment, the detecting of the security anomaly comprises: detecting the security anomaly through a security device or security system pre-established in each of the plurality of environments in the IoBE; and detecting a security anomaly that is not detected through the pre-established security device or security system by analyzing at least one of log data and a security event occurring within the IoBE.

According to an exemplary embodiment, the collecting of attack data related to the detected security anomaly and the analyzing of an attack type based on the collected data comprises; analyzing the attack type by comparing the collected attack data with previously disclosed information; and estimating the attack type by analyzing a correlation with other log data in the IoBE when it is impossible to analyze the attack type by comparing the collected attack data with the previously disclosed information.

According to an exemplary embodiment, the dynamically combining of the response techniques based on the analyzed attack type comprises: analyzing an attack type of each of a plurality of security threats included in the security anomaly from the collected attack data; and dynamically combining the response techniques based on a cyber kill chain stage of each of the plurality of security threats and the analyzed attack type.

According to an exemplary embodiment, the dynamically combining of the response techniques comprises: combining the response techniques using a response model that dynamically combines the response techniques to correspond to linkage of the plurality of security threats.

According to an exemplary embodiment, the method further comprises: recovering damaged data in the IoBE after the response to the security anomaly is completed; and updating the response model using log data occurring according to the response to the security anomaly.

According to an exemplary embodiment, the plurality of environments comprise at least one of digital healthcare, a smart factory, a smart grid, a smart building, and a cooperative intelligent transport system (C-ITS).

According to an aspect of an embodiment, a security management system of Internet of blended environment (IoBE) in which a plurality of environments are connected to each other through a network is disclosed. The security management system includes: at least one computing device; a monitoring and anomaly detection unit configured to detect a security anomaly occurring through an attack surface existing in a device included in each of the plurality of environments in the IoBE or in a network connection section between the plurality of environments; an inspection unit configured to collect attack data related to the security anomaly detected through the monitoring and anomaly detection unit, and analyze the collected attack data; and a response unit configured to dynamically combine response techniques for responding to the security anomaly based on the analyzed attack data, and perform an automatic response to the security anomaly through the combined response techniques.

According to an exemplary embodiment, the monitoring and anomaly detection unit detects the security anomaly using a security device or security system pre-established in each of the plurality of environments in the IoBE, and detects a security anomaly that is not detected through the pre-established security device or security system by analyzing at least one of log data and a security event occurring within the IoBE.

According to an exemplary embodiment, the inspection unit analyzes the attack type by comparing the collected attack data with previously disclosed information, and estimates the attack type by analyzing a correlation with other log data in the IoBE when it is impossible to analyze the attack type by comparing the collected attack data with the previously disclosed information.

According to an exemplary embodiment, the response unit dynamically combine the response techniques based on an attack type of each of a plurality of security threats included in the security anomaly and a cyber kill chain stage of each of the plurality of security threats.

According to an exemplary embodiment, the response unit comprises a response model that dynamically combines response techniques according to the detected security anomaly by using information about matching response techniques for respective security threats, dynamically combines response techniques to correspond to linkage of the security threats through the response model, and performs a response to the security anomaly by using the combined response techniques.

According to an exemplary embodiment, the security management system further includes a management unit configured to recover damaged data in the IoBE after the response to the security anomaly is completed, and update the response model using log data occurring according to the response to the security anomaly.

According to an exemplary embodiment, the plurality of environments comprise at least one of digital healthcare, a smart factory, a smart grid, a smart building, and a cooperative intelligent transport system (C-ITS).

### BRIEF DESCRIPTION OF THE DRAWINGS

These and/or other aspects will become apparent and more readily appreciated from the following description of the embodiments, taken in conjunction with the accompanying drawings in which:

FIG. 1 is a view illustrating an example of a configuration of Internet of blended environment (IoBE) and various data managed through the IoBE according to an embodiment;

FIG. 2 is a view for explaining examples of various types of security threats and attack surfaces that may occur in IoBE;

FIGS. 3 and 4 are views of collaborative units of blended environment (CUBE) configured according to a dynamic combination of security threats that may be generated within IoBE and response techniques, according to an embodiment; and

FIGS. 5 to 9 are views for explaining a security management method of IoBE using a model in which CUBE is applied to security orchestration and response (SOAR).

### DETAILED DESCRIPTION

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that the present disclosure will be thorough and complete, and will fully convey the scope of the inventive concept to one of ordinary skill in the art.

It will be understood that, although the terms first, second, etc. may be used herein to describe various members, regions, layers, sections, and/or components, these members, regions, layers, sections, and/or components should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of this disclosure, a first component may be named as a second component, and a second component may be named as a first component.

Unless otherwise defined, all terms (including technical and scientific terms) used herein have the same meaning as commonly understood by one of ordinary skill in the art to which the inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

As used herein, the term “and/or” includes any and all combinations of one or more of the associated listed items.

Hereinafter, embodiments of the inventive concept will be described in detail with reference to the accompanying drawings.

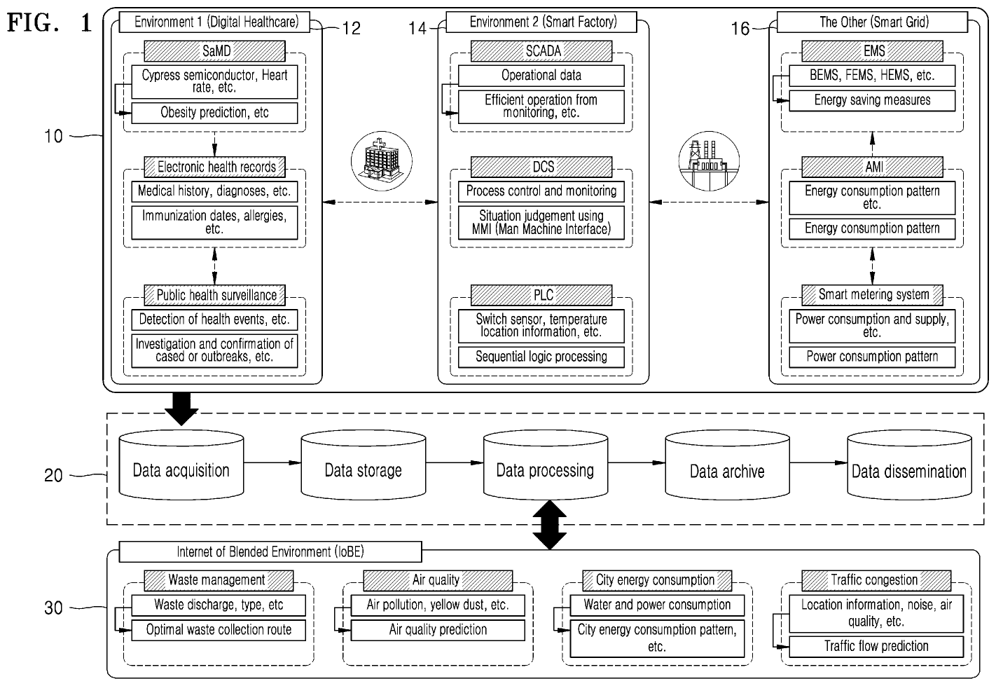

FIG. 1 is a view illustrating an example of a configuration of Internet of blended environment (IoBE) and various data managed through the IoBE according to an embodiment.

According to the fourth industrial revolution, information and communication technology (ICT) has developed into convergence technologies such as nanotechnology, biotechnology, information technology, and cognitive science, and the connectivity between technologies is maximizing. As an example of this, as with the advent of Massive IoT, a hyper-connected network environment in which countless devices in daily life are connected to each other at high density, evolution into a hyper-connected society in which people, objects, and spaces constantly create, collect, and share data through the Internet is taking place.

In addition, due to the recent development of IT technology, various environments are complexly connected to each other. For example, as various environments (convergence environments) such as smart buildings and smart factories are complexly connected to each other, the environment to which Massive IoT is applied may become more complex. In this specification, a technology in which these various environments are connected to each other through a network (Internet) is defined as IoBE.

Referring to FIG. 1, the IoBE described above may include a plurality of environments 10 and a data management unit 20 that manages data provided from the plurality of environments 10.

Each of the plurality of environments 10 may include a digital healthcare 12, a smart factory 14, and a smart grid 16, but this is only an example for convenience of description. The plurality of environments 10 may include various environments (e.g., smart building, cooperative intelligent transport system (C-ITS), etc.) in addition to the above-described environments.

Each of the plurality of environments 10 may correspond to a kind of convergence environment in which various IT technology-based hardware/software solutions or systems are implemented. For example, in the digital healthcare 12, software as medical device (SaMD), electronic health records, public health surveillance, etc. are implemented, and various data related to healthcare may be generated or obtained. Supervisory control and data acquisition (SCADA), a distributed control system (DCS), a programmable logic controller (PLC), etc. are implemented in the smart factory 14, and various data related to the operation or status of a factory may be generated or obtained. In the smart grid 16, an energy management system (EMS), advanced metering infrastructure (AMI), an intelligent metering system, etc. are implemented, and various data such as data related to power management in a building, factory, or home, data related to power consumption/supply, etc. may be generated or obtained. In the IoBE, various information or services may be provided by combining data generated and obtained in each of the plurality of environments 10.

The data management unit 20 may manage data provided from each of the plurality of environments 10. For example, the data management unit 20 may manage data according to processes of data acquisition, data storage, data processing, data archiving, and data dissemination.

Data acquisition is a process of collecting data generated in each of the plurality of environments 10, and various types of data may be collected through different domains, communication standards, and routes according to each environment. For example, the data management unit 20 may collect digital images of medical devices in the digital healthcare 12 according to a digital imaging and communications in medicine (DICOM) standard. Data storage is a process of storing collected data in a data center, and data in various formats may be stored according to the type of data.

Data processing is a process of processing the collected and stored data, and may refer to a process of processing raw data collected and stored from the plurality of environments 10 into information required by a service or system in the IoBE. For example, the data management unit 20 may generate new data or information in a form usable in a service or system within the IoBE by determining and interpreting a connection relationship or mutual correlation between data provided from different environments. Referring to the example of FIG. 1, a service or system that provides information or data such as waste management, air quality, urban energy consumption, traffic congestion, etc. may exist in the IoBE, and each service or system may obtain and provide necessary data from among various data collected from the different environments 10 through combination or processing according to various other methods. For example, the data management unit 20 may analyze energy consumption data generated from the smart grid 16 and power usage data generated in a smart building and generate energy waste information through analysis of an energy consumption pattern of the entire city, and the generated information may be utilized through a service or system related to urban energy consumption within the IoBE.

Data archiving is a process of enabling rapid retrieval of data by generating meta data to account for long-term retention of the collected and processed data. Data dissemination may be a process of distributing or transmitting data to a user through a user interface or the like.

For example, the IoBE, in which the various environments described above are complexly connected to each other, may create a smart city environment, and with the development of future technology, the IoBE may enable the creation of a wider smart society and smart nation through the connection between smart cities.

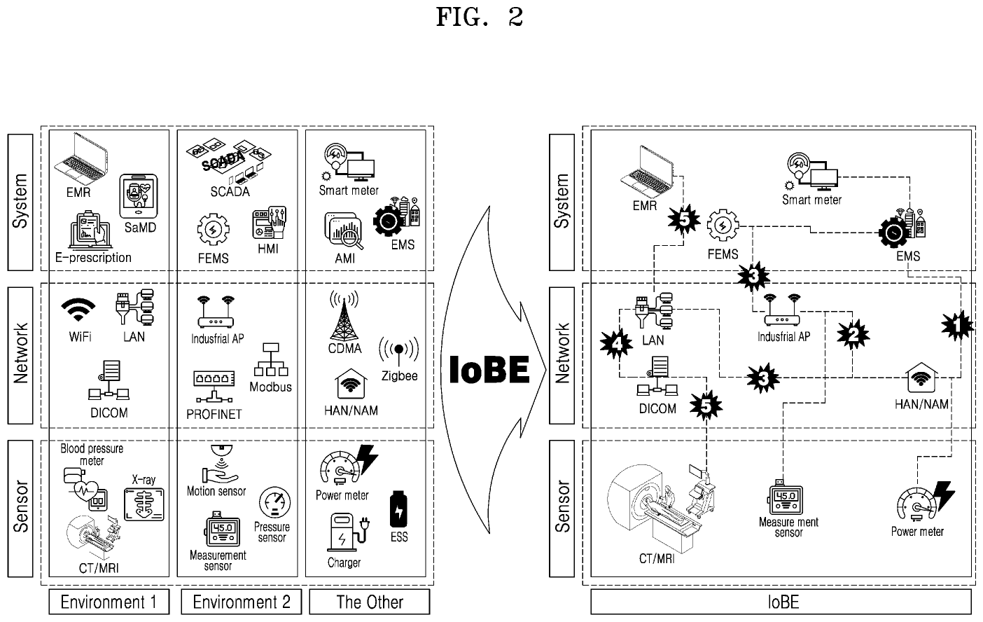

However, in such a blended environment, as the connection between the environments becomes complex and diversified, vulnerability or an attack surface where security threats may occur may increase. This will be described in more detail below with reference to FIG. 2.

FIG. 2 is a view for explaining examples of various types of security threats and attack surfaces that may occur in IoBE.

As a new environment is introduced along with various environments that make up the IoBE, device architecture, network protocol, platform, etc. may become more complex, and this may increase vulnerability or an attack surface where security threats may occur, and patterns of security threats may also become complex.

Referring to FIG. 2, as a sensor device, a network device, and a system included in each environment 10 are connected to sensor devices, network devices, and/or systems in the same or different environments, new attack surfaces may arise. A security threat in this blended environment are defined as a blended threat. In particular, even for the same type of security threats, when an environment or attack surface in which a security threat may occur is diversified, the response thereto will inevitably be diversified, so the response to the blended threat will inevitably be very complex.

In the right figure of FIG. 2 indicate examples of attack scenarios according to blended threats, and each attack scenario is shown in Table 1 below.

TABLE 1

| No. | Description |
|---|---|
| 1 | Penetration into HAN/NAN server through known vulnerability of |
| | end point and protocol within smart grid |
| 2 | Remote control of FEMS through industrial AP connection of |
| | unauthorized device |
| 3 | Modification of FEMS energy usage in smart factory or penetration |
| | into digital healthcare server |
| 4 | Data theft through DICOM protocol vulnerability |
| 5 | EMR data modulation through CT/MRI image data modulation |

As described above, various and complex attack scenarios may occur by fusing attack surfaces that may be generated according to a connection relationship between components in the IoBE. Accordingly, in order to respond to blended threats, it is necessary not only to analyze vulnerability of each component, but also to analyze an attack surface through which a cyber attack may be made through the analysis of the connection relationship between the components.

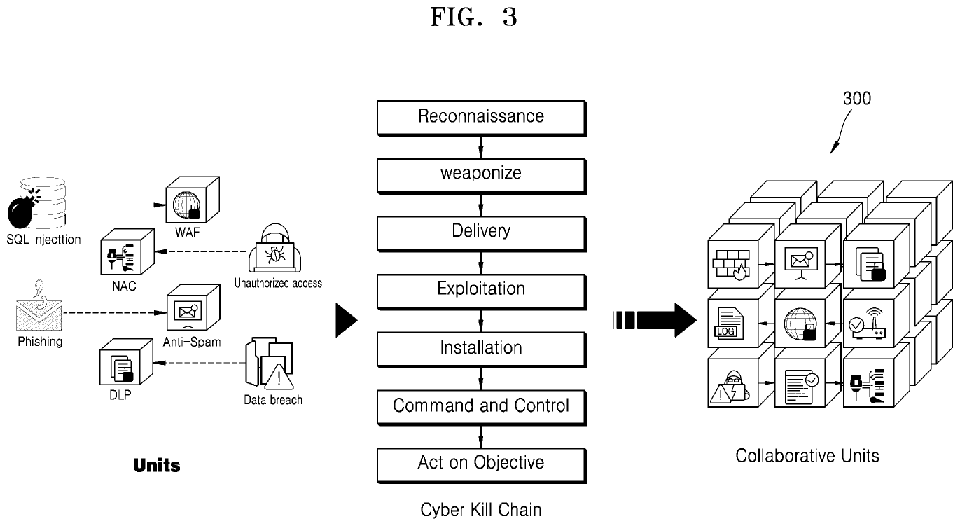

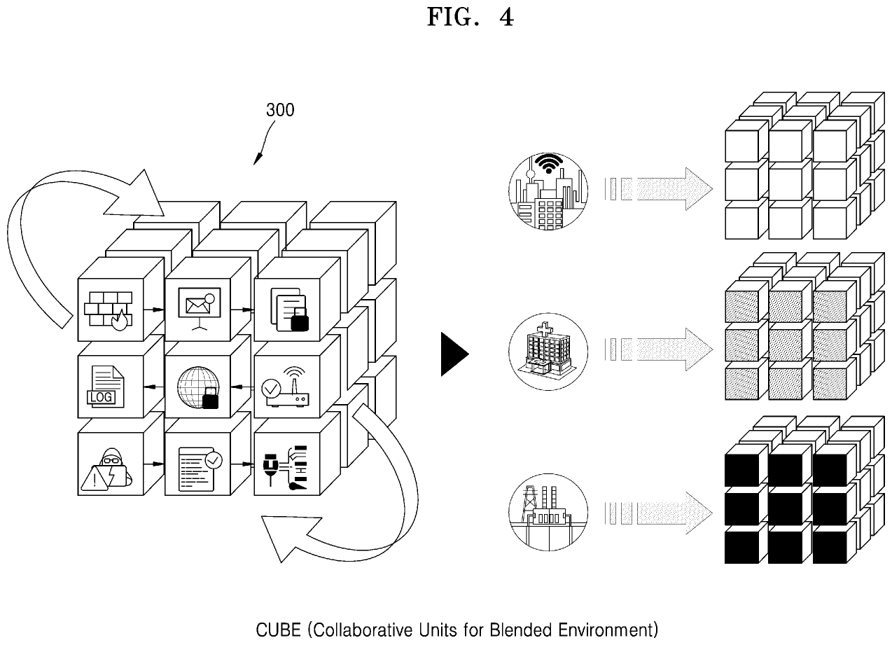

FIGS. 3 and 4 are views of collaborative units of blended environment (CUBE) configured according to a dynamic combination of security threats that may be generated within IoBE and response techniques, according to an embodiment.

In the case of the IoBE, because data is generated in a blended environment and transmitted across various paths and domains, a security threat occurring in each component such as a wireless LAN section or an edge network section and a security level required to respond to the security threat may be different.

On the other hand, because the types of security threats included in the cyber attack correspond to the existing types, a response technology for each security threat may correspond to the existing technology. For example, a response technology for SQL injection may correspond to a web application firewall (WAF), and a response technology for phishing emails may correspond to blocking spam emails or blocking senders. Based on this, as shown in the left figure of FIG. 3, in the present disclosure, a pair of a security threat and a response technology for the security threat may be defined as a unit.

Recently, a cyber attack may be caused by a combination of various security threats, so several units may be combined according to the stage of the cyber attack, and the combination of these units may be dynamically changed according to a characteristic of the cyber attack. A dynamic combination of the cyber attack's step-by-step response techniques may be defined as collaborative units.

As described in FIG. 3, according to the present disclosure, in a cyber attack, various security threats may be linked in stages according to a cyber kill chain, and response techniques corresponding thereto may be combined in stages. The cyber kill chain corresponds to an analysis model that defines seven stages of the cyber attack to analyze the cyber attack based on process, identify threat factors applied at each stage, and mitigate the cyber attack. The seven stages include reconnaissance, weaponization, delivery, exploitation, installation, command & control, and act on objective stages. The reconnaissance stage is investigating/identifying/selecting a target, the weaponization stage is preparing cyber weapons (malware, Trojan, etc.) using automated tools, and the delivery stage is distributing the cyber weapons to the target. The exploitation stage is operating the distributed cyber weapons, and the installation stage is installing a malicious program on the target. The command & control stage is establishing a remote control channel to the target, and the act on objective stage is performing an attack such as collecting information or destroying a system. Because an attack method is different for each stage of the cyber kill chain, a response technology corresponding thereto may also be different for each stage. Accordingly, because security threats within a cyber attack and their respective cyber kill chain stages are identified, response techniques for the cyber attack may be selected and combined.

When these collaborative units are applied to the IoBE, the collaborative units may be dynamically combined in response to a blended threat occurring in a blended environment of the IoBE, and this may be defined as collaborative units for blended environment (CUBE). The CUBE may be flexibly changed according to different security policies or response systems of environments within the IoBE to enable an optimal security response.

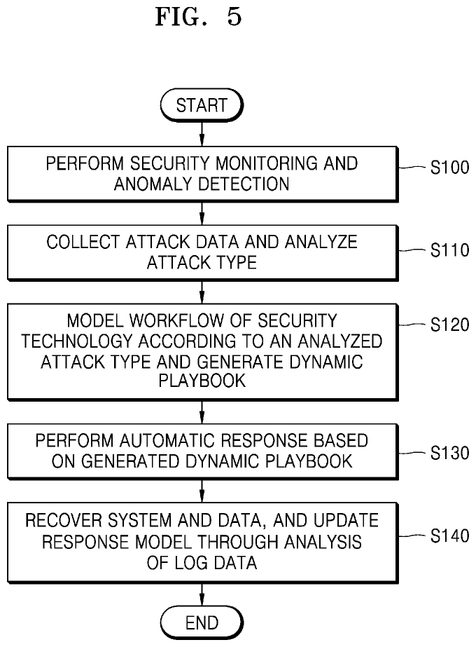

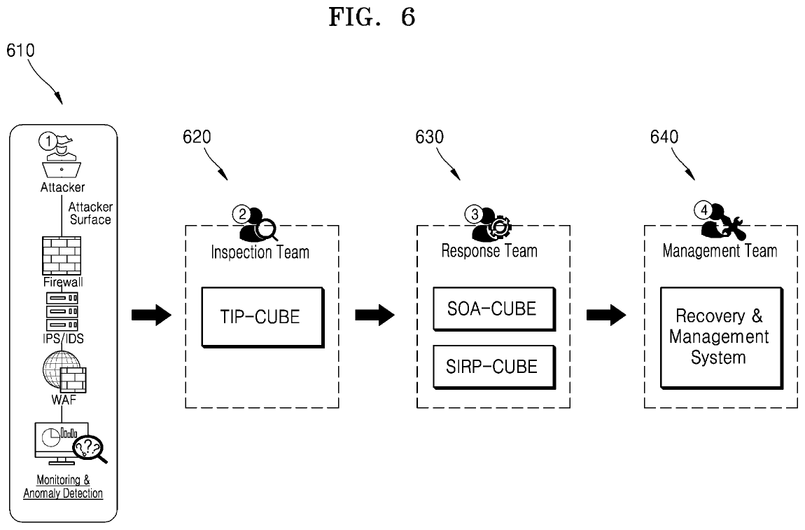

FIGS. 5 to 9 are views for explaining a security management method of IoBE using a model in which CUBE is applied to security orchestration and response (SOAR).

In the present disclosure, a model (SOAR-CUBE) in which the CUBE described above is applied to the SOAR may be defined. SOAR-CUBE may include Threat Intelligence Platform with CUBE (TIP-CUBE), which provides threat data acquisition and correlation analysis, security orchestration and automation with CUBE (SOA-CUBE), which provides orchestration and automation between response techniques, and a security incident response platform with CUBE (SIRP-CUBE), an automatic response process for blended threats.

The TIP-CUBE performs data correlation analysis by collecting threat data based on blended threats generated by the IoBE. The TIP-CUBE may identify attack information such as a source by tracing back a path of blended threats through a correlation between data, and may minimize a response time of cyber attacks through blended threats by linking with the existing security solutions used in each environment of the IoBE.

The SOA-CUBE is a configuration for orchestration and automation between response techniques in the CUBE. Because various security technologies are dynamically combined in the CUBE, linkage between security technologies may be required. Accordingly, the SOA-CUBE enables linkage between different security technologies through workflow modeling that connects different inputs and outputs between security technologies and generation of a dynamic playbook, which is a response system consisting of a series of logics for responding to cyber attacks.

The SIRP-CUBE corresponds to the automation technology of a response system for the occurrence of cyber attacks or other security incidents including blended threats within the IoBE. The SIRP-CUBE classifies the types of blended threats to efficiently respond to numerous cyber attacks and security incidents with minimal human intervention, and enables automation of the response system through the development and improvement of technologies to automatically detect and respond to blended threats.

An embodiment of a security management method in a blended environment (IoBE) to which such a SOAR-CUBE model is applied is shown in FIGS. 5 to 9. The security management method according to an embodiment may be performed by a security management system including at least one computing device (server, etc.). For example, the security management system may be connected to various devices or network devices included in environments constituting the IoBE to perform a security management operation for the IoBE, and may include the SOAR-CUBE model described above.

Referring to FIGS. 5 to 9, the security management method according to an embodiment may include operation S100 of performing security monitoring for the IoBE and anomaly detection.

Attackers may attempt to penetrate into blended environments through various attack surfaces within the IoBE. A monitoring and anomaly detection unit 610 of a security management system may detect security anomalies through a security device or system previously built in environments included in the IoBE. The monitoring and anomaly detection unit 610 may define an attack pattern mainly used for a cyber attack in advance and block attacker's penetration based on a pattern. When the security device or system previously built fails to block the attacker's penetration by bypassing a predefined pattern, the monitoring and anomaly detection unit 610 may detect a security anomaly by analyzing a security event or log data occurring within the IoBE. For example, the monitoring and anomaly detection unit 610 may include an intrusion prevention system (IPS), an intrusion detection system (IDS), a firewall, a WAF, and/or security information and event management (SIEM).

The security management method may include operation S110 of collecting attack data and analyzing an attack type when an anomaly is detected.

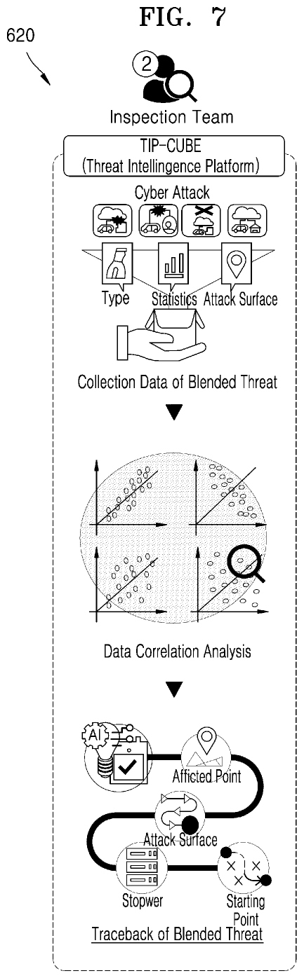

Referring to FIG. 7 together, when a security anomaly (cyber attack) is detected by the monitoring and anomaly detection unit 610, an inspection unit (Inspection) 620 of a security management system of the IoBE may collect data (attack data) related to the detected anomaly through TIP-CUBE, and classify an attack type by analyzing the collected data. According to an embodiment, the inspection unit 620 may check the attack type by comparing the attack data with open source intelligence (OSINT) public threat information. If the detected security anomaly is an attack that is not known in advance or it is difficult to analyze the type of the security anomaly due to the intelligence of the attack, the inspection unit 620 may analyze a correlation with log data in the IoBE to identify blended threats included in the cyber attack, and estimate a path or type of the cyber attack.

The security management method may include operation S120 of modeling a workflow of a security technology (response technology) according to an analyzed attack type and generating a dynamic playbook, and operation S130 of performing an automatic response based on the generated dynamic playbook.

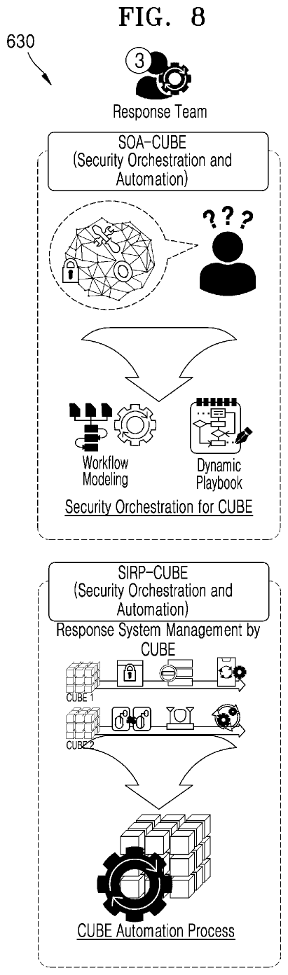

Referring to FIG. 8 together, a response unit 630 of the security management system may protect components in the IoBE by responding to a security anomaly analyzed by the inspection unit 620. The response unit 630 may include the SOA-CUBE and SIRP-CUBE described above.

The response unit 630 may generate a workflow and a dynamic playbook of response techniques for responding to the security anomaly according to characteristics (types of compound threats included in a cyber attack, etc.) of the analyzed the security anomaly, a cyber kill chain stage, and the like. In more detail, the response unit 630 may generate a workflow and a dynamic playbook for responding to the security anomaly by dynamically combining the response techniques through the CUBE described in FIGS. 3 to 4. In this case, the response unit 630 may connect respective inputs/outputs of the combined response techniques through the SOA-CUBE to enable smooth operation of the response techniques.

The response unit 630 may perform an automatic response to the security anomaly through the SIRP-CUBE based on the generated workflow and dynamic playbook.

After the automatic response to the security anomaly is completed, the security management method may include operation S140 of recovering system and data in the IoBE, and updating a response model (CUBE) through the analysis of log data.

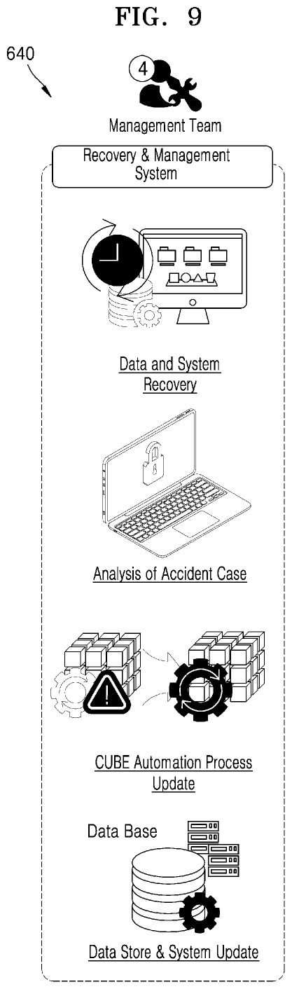

Referring to FIG. 9 together, a management unit 640 of a security management system may recover damaged data or a system according to a response to a detected security anomaly. In addition, the management unit 640 may analyze and manage (store, etc.) log data occurring in the SOAR-CUBE, etc. according to the response to the security anomaly, and update an SOAR-CUBE model. Accordingly, the security management system may detect a security anomaly similar to that of IoBE more effectively in the future, and may respond more efficiently when the same attack occurs by updating the response system.

According to the inventive concept of the present disclosure, by dynamically creating optimal response solutions for various and blended security threats occurring in a blended environment and responding with the optimal response solutions, it is possible to effectively respond to various security threats in a blended environment and protect the system.

In addition, because a response model is updated through the analysis of data related to security threats, continuous performance improvement and error correction of the response model may be possible.

While the present disclosure has been particularly shown and described with reference to embodiments thereof, it will be understood that various changes in form and details may be made therein without departing from the spirit and scope of the following claims.

Descriptions of features or aspects within each embodiment should typically be considered as available for other similar features or aspects in other embodiments.

What is claimed is:

1. A security management method of Internet of blended environment (IoBE) in which a plurality of environments are connected to each other through a network, the security management method comprising:
detecting a security anomaly occurring through an attack surface existing in a device included in each of the plurality of environments in the IoBE or in a network connection section between the plurality of environments;
collecting attack data related to the detected security anomaly and analyzing an attack type based on the collected data;
dynamically combining response techniques based on the analyzed attack type; and
performing an automatic response to the security anomaly based on the combined response techniques.

2. The security management method of claim 1, wherein the detecting of the security anomaly comprises:
detecting the security anomaly through a security device or security system pre-established in each of the plurality of environments in the IoBE; and
detecting a security anomaly that is not detected through the pre-established security device or security system by analyzing at least one of log data and a security event occurring within the IoBE.

3. The security management method of claim 1, wherein the collecting of attack data related to the detected security anomaly and the analyzing of an attack type based on the collected data comprises;
analyzing the attack type by comparing the collected attack data with previously disclosed information; and
estimating the attack type by analyzing a correlation with other log data in the IoBE when it is impossible to analyze the attack type by comparing the collected attack data with the previously disclosed information.

4. The security management method of claim 1, wherein the dynamically combining of the response techniques based on the analyzed attack type comprises:
analyzing an attack type of each of a plurality of security threats included in the security anomaly from the collected attack data; and
dynamically combining the response techniques based on a cyber kill chain stage of each of the plurality of security threats and the analyzed attack type.

5. The security management method of claim 4, wherein the dynamically combining of the response techniques comprises:
combining the response techniques using a response model that dynamically combines the response techniques to correspond to linkage of the plurality of security threats.

6. The security management method of claim 5, further comprising:
recovering damaged data in the IoBE after the response to the security anomaly is completed; and
updating the response model using log data occurring according to the response to the security anomaly.

7. The security management method of claim 1, wherein the plurality of environments comprise at least one of digital healthcare, a smart factory, a smart grid, a smart building, and a cooperative intelligent transport system (C-ITS).

8. A security management system of Internet of blended environment (IoBE) in which a plurality of environments are connected to each other through a network, wherein the security management system includes at least one computing device, the security management system comprising:
a monitoring and anomaly detection unit configured to detect a security anomaly occurring through an attack surface existing in a device included in each of the plurality of environments in the IoBE or in a network connection section between the plurality of environments;
an inspection unit configured to collect attack data related to the security anomaly detected through the monitoring and anomaly detection unit, and analyze the collected attack data; and
a response unit configured to dynamically combine response techniques for responding to the security anomaly based on the analyzed attack data, and perform an automatic response to the security anomaly through the combined response techniques.

9. The security management system of claim 8, wherein the monitoring and anomaly detection unit detects the security anomaly using a security device or security system pre-established in each of the plurality of environments in the IoBE, and
detects a security anomaly that is not detected through the pre-established security device or security system by analyzing at least one of log data and a security event occurring within the IoBE.

10. The security management system of claim 8, wherein the inspection unit analyzes the attack type by comparing the collected attack data with previously disclosed information, and
estimates the attack type by analyzing a correlation with other log data in the IoBE when it is impossible to analyze the attack type by comparing the collected attack data with the previously disclosed information.

11. The security management system of claim 8, wherein the response unit dynamically combine the response techniques based on an attack type of each of a plurality of security threats included in the security anomaly and a cyber kill chain stage of each of the plurality of security threats.

12. The security management system of claim 11, wherein the response unit comprises a response model that dynamically combines response techniques according to the detected security anomaly by using information about matching response techniques for respective security threats,
dynamically combines response techniques to correspond to linkage of the security threats through the response model, and
performs a response to the security anomaly by using the combined response techniques.

13. The security management system of claim 12, further comprising:
a management unit configured to recover damaged data in the IoBE after the response to the security anomaly is completed, and update the response model using log data occurring according to the response to the security anomaly.

14. The security management system of claim 8, wherein the plurality of environments comprise at least one of digital healthcare, a smart factory, a smart grid, a smart building, and a cooperative intelligent transport system (C-ITS).
